(19) United States
(12) Patent Application Publication
(10) Pub. No.: US 2017/0291781 A1
(43) Pub. Date: Oct. 12, 2017

(54) PAPER SHEET STORAGE DEVICE AND PAPER SHEET STORAGE METHOD

(71) Applicant: FUJITSU FRONTECH LIMITED, lnagi (JP)

(72) Inventors: Hiroshi YANAGIDA, lnagi (JP); Daiki HARAI, lnagi (JP); Ryo FUJIWARA, lnagi (JP); Tomoyuki TAMAHASHI, lnagi (JP); Koichi HOSOYAMA, lnagi (JP)

(73) Assignee: FUJITSU FRONTECH LIMITED, lnagi (JP)

(21) Appl. No.: 15/633,202

(22) Filed: Jun. 26, 2017

Related U.S. Application Data
(63) Continuation of application No. PCT/JP2015/050538, filed on Jan. 9, 2015.

(51) Int. Cl. B65H 5/28; G07D 11/00; G07F 7/04

(52) U.S. Cl. CPC B65H 5/28; G07F 7/04; G07D 11/0006; B65H 2701/1912; B65H 2301/4191

(57) ABSTRACT

A paper sheet storage device includes a supply reel which has a constant load spring formed of a metal band and around which the metal band is rolled, and a winding drum around which banknotes are wound together with the metal band supplied from the supply reel.

### CROSS-REFERENCE TO RELATED APPLICATION

This application is a continuation application of International Application PCT/JP2015/050538, filed on Jan. 9, 2015 and designating the U.S., the entire contents of which are incorporated herein by reference.

### FIELD

The present invention relates to a paper sheet storage device and a paper sheet storage method.

### BACKGROUND

A banknote handling device such as an automated teller machine (ATM) includes a banknote storage device that temporarily stores loaded banknotes. In this type of banknote storage device, banknotes are stored by winding banknotes around a winding drum together with a tape supplied from a supply reel.
Patent Literature 1: Japanese Laid-open Patent Publication No. 2009-107824
Patent Literature 2: Japanese Laid-open Patent Publication No. 2013-199365
Patent Literature 3: Japanese Laid-open Patent Publication No. 2001-122470

The banknote storage device will be described with reference to the drawings. FIGS. 7A and 7B are schematic diagrams for describing a banknote storing operation in a banknote storage device according to a related art of the present application. As illustrated in FIGS. 7A and 7B, the banknote storage device includes a supply reel (not illustrated) around which a tape 114 is rolled and a winding drum 113 around which banknotes 102 are wound together with the tape 114 supplied from the supply reel. A plurality of guide rollers 118 that conveys the tape 114 is disposed between the supply reel and the winding drum 113, and the plurality of guide rollers 118 forms a conveying path.

FIG. 8 is a perspective view for describing a torsion spring and a torque limiter included in the supply reel of the banknote storage device according to the related art of the present application. As illustrated in FIG. 8, in a banknote storage device 111 according to the related art, in order to wind the banknotes 102 appropriately along the circumferential surface of the winding drum 113 together with the tape 114, the tape 114 needs to be supplied in a state in which constant tension is applied to the tape 114. Therefore, a spring mechanism 121 including a torsion spring that applies tension to the tape 114 is incorporated into a supply reel 112 around which the tape 114 is rolled. Furthermore, a torque limiter 122 for making the tension applied to the tape 114 constant is provided in a rotating shaft 125 of the supply reel 112.

A light blocking film is formed at both ends of the tape 114 having a light transmitting property, and a optical sensor 116 detects both ends by detecting a change in the reception state of the detection light. In this way, the banknote storage device 111 calculates a winding amount of the tape 114 wound around the winding drum 113 and counts the number of banknotes wound around the winding drum 113 together with the tape 114.

As a technique of applying tension to the tape, a configuration in which a spring that biases the tape is attached to the inner side of the supply reel is known.

However, as described above, in a configuration in which a torsion spring or a torque limiter is used to apply constant tension to the tape, a space in which a torsion spring or a torque limiter is disposed needs to be secured in the rotating shaft or inside the supply reel. Due to this, the structure of the supply reel becomes complex and the size thereof increases.

In the banknote storage device, since the tape formed of a resin film is used, when banknotes are wound around the winding drum together with the tape, the banknotes are electrostatically charged due to friction between the tape and the banknotes. Particularly, in the winter where the humidity is low, the banknotes are easily charged inside the banknote storage device. As a result of the electrostatic charging, troubles may occur in a conveying system or an electric system. Conventionally, as a countermeasure for avoiding troubles caused by the electrostatic charging, a method of forming an antistatic film on a tape, forming a guide roller or the like using an antistatic member, or arranging a neutralizing brush to prevent or suppress charging of banknotes is employed. However, the use of an antistatic film increases the manufacturing cost, and depending on an environmental condition, it is difficult to prevent charging sufficiently even when an antistatic material is used. Moreover, in order to obtain a satisfactory neutralization effect of a neutralizing brush, the neutralizing brush needs to be attached to a large number of places. However, due to a limitation on the inner space of a banknote handling device, it is difficult to arrange the neutralizing brush in a large number of places and to obtain a sufficient neutralization effect.

FIG. 9 is a schematic diagram for describing a problem of a tape used by the banknote storage device according to the related art of the present application. Moreover, since the tape 114 formed of a resin film is highly flexible, as illustrated in FIG. 9, the tape 114 is disordered during the winding operation of the tape 114, and a state in which the tape 114 is entangled (hereinafter, referred to as a jam) is likely to occur. When a jam occurs, the tape 114 may be damaged or broken when the banknote 102 is removed from the space between the tapes 114 wound around the winding drum 113 or the entangled tape 114 is loosened. As described above, due to the low durability of the tape 114, the reliability of the winding operation decreases.

As described above, in the technique in which a spring that applies tension to a tape is incorporated into a supply reel, banknotes are wound around a winding drum together with the tape. Due to this, this technique also has the problem associated with charging of the banknote and the problem associated with damage or breakage of the tape resulting from a jam.

### SUMMARY

According to an aspect of the embodiments, a paper sheet storage device includes: a supply reel which has a constant load spring formed of a metal band and around which the metal band is rolled; and a winding drum around which a paper sheet is wound together with the metal band supplied from the supply reel.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an entire banknote handling device including a banknote storage device according to an embodiment.

FIG. 2 is a perspective view illustrating the banknote storage device according to the embodiment.

FIG. 3 is a plan view illustrating a first detection unit and a second detection unit of the banknote storage device according to the embodiment.

FIG. 4 is a side view schematically illustrating the banknote storage device according to the embodiment.

FIG. 5 is a plan view for describing a state, in which an end of a metal band of a constant load spring according to the embodiment, is detected.

FIG. 6 is a schematic diagram for describing a state, in which an end of a metal band of a constant load spring according to the embodiment, is detected.

FIG. 7A is a schematic diagram for describing a banknote storing operation in a banknote storage device according to a related art of the present application.

FIG. 7B is a schematic diagram for describing a banknote storing operation in the banknote storage device according to the related art of the present application.

FIG. 8 is a perspective view for describing a torsion spring and a torque limiter included in a supply reel of the banknote storage device according to the related art of the present application.

FIG. 9 is a schematic diagram for describing a problem of a tape used by the banknote storage device according to the related art of the present application.

### DESCRIPTION OF EMBODIMENTS

Hereinafter, a banknote storage device and a banknote storage method according to an embodiment, related to a paper sheet storage device and a paper sheet storage method disclosed in the present application will be described in detail based on the drawings. The paper sheet storage device and the paper sheet storage method disclosed in the present application are not limited to the following embodiments.

### Embodiment

[Configuration of Banknote Handling Device]

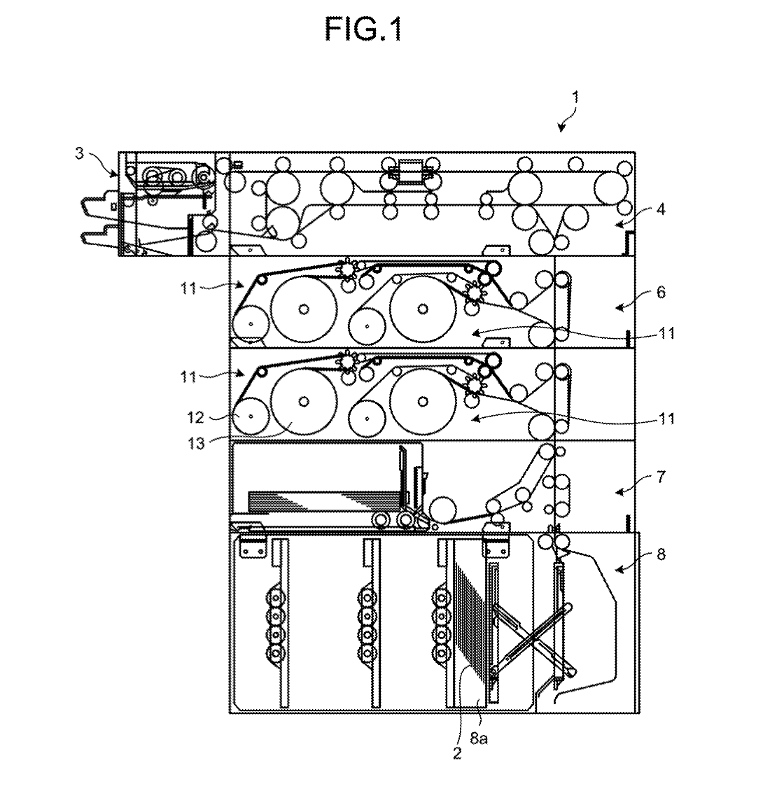

FIG. 1 is a schematic diagram illustrating an entire banknote handling device including a banknote storage device according to an embodiment. As illustrated in FIG. 1, a banknote handling device 1 according to the embodiment includes a loading and unloading unit 3 that loads and unloads banknotes 2, a discrimination unit 4 that discriminates the banknotes 2 loaded into the loading and unloading unit 3, and a temporary storage unit 11 that temporarily stores the banknotes 2 conveyed from the discrimination unit 4. The banknote handling device 1 further includes a circulation unit 6 that circulates the banknotes 2 stored in the temporary storage unit 11, an unloading unit 7 in which the banknotes 2 to be unloaded are stored, a storage unit 8 that stores the banknotes 2 in a storage 8a. The temporary storage unit 11 incorporated into the banknote handling device 1 corresponds to the banknote storage device according to the embodiment. In the present embodiment, although the banknote 2 is used as an example of a paper sheet, the paper sheet is not limited to the banknote.

[Configuration of Banknote Storage Device]

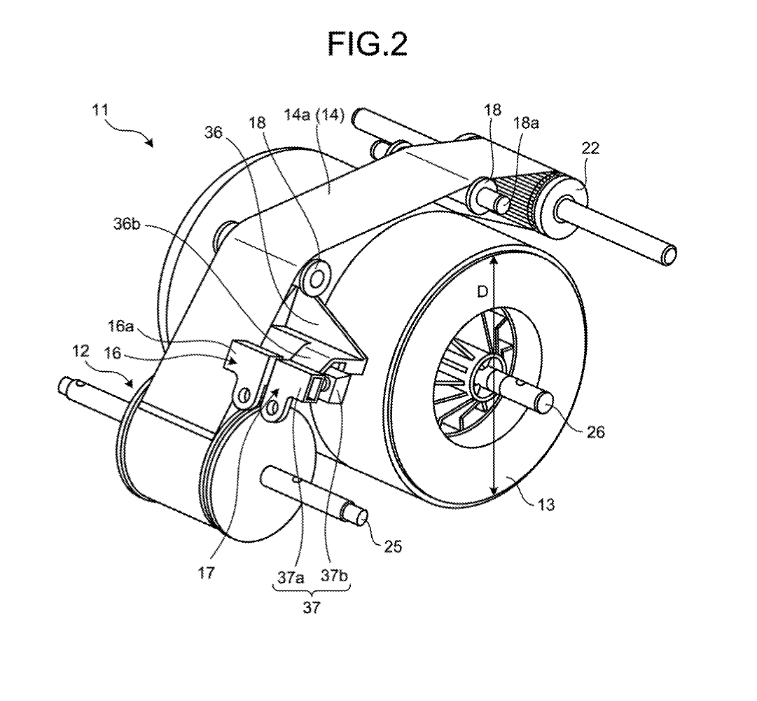

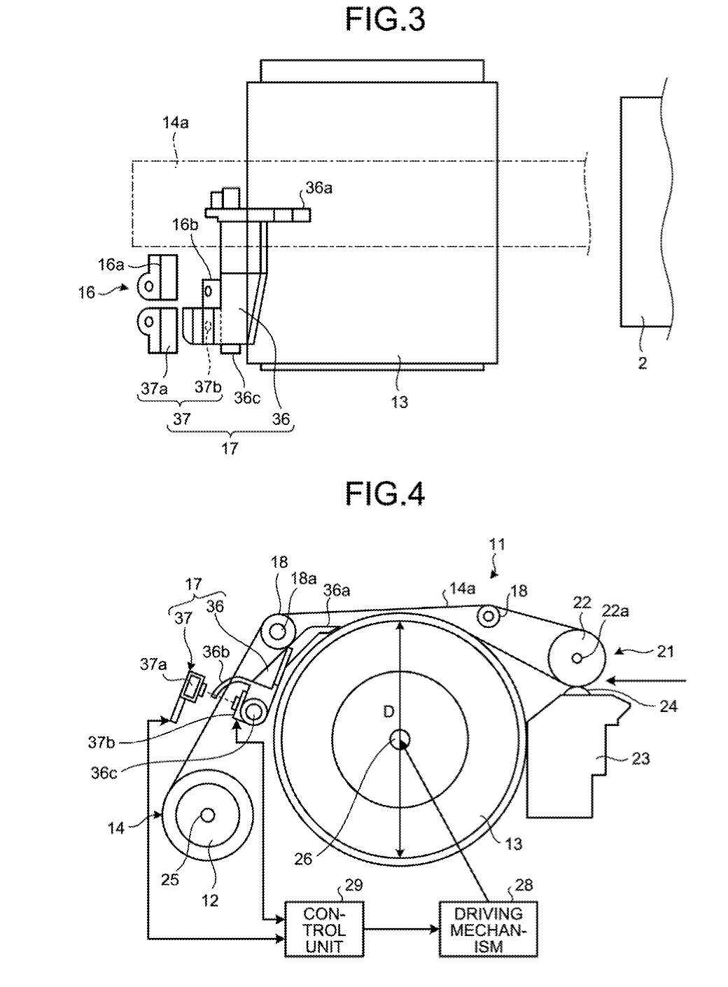

FIG. 2 is a perspective view illustrating a banknote storage device according to the embodiment. FIG. 3 is a plan view illustrating a first detection unit and a second detection unit of the banknote storage device according to the embodiment. FIG. 4 is a side view schematically illustrating the banknote storage device according to the embodiment.

As illustrated in FIG. 2, the banknote storage device 11 according to the embodiment includes a supply reel 12 and a winding drum 13. The supply reel 12 has a constant load spring 14 formed of a metal band 14a and the metal band 14a is rolled around the supply reel 12. The banknotes 2 are wound around the winding drum 13 together with the metal band 14a that is supplied from the supply reel 12.

As illustrated in FIGS. 2 and 3, the banknote storage device 11 includes a first detection unit 16 and a second detection unit 17. The first detection unit 16 detects a supply amount of the metal band 14a that is supplied from the supply reel 12. The second detection unit 17 detects the winding drum 13 of which the outer diameter becomes equal to or larger than a predetermined outer diameter (hereinafter referred to as a winding diameter) when the banknotes 2 are wound around the winding drum 13 together with the metal band 14a. Moreover, the banknote storage device 11 includes a plurality of guide rollers 18 that is disposed between the supply reel 12 and the winding drum 13. The plurality of guide rollers 18 forms a conveying path along which the metal band 14a, which is supplied from the supply reel 12, is conveyed to the winding drum 13. The guide roller 18 is rotatably supported by a spindle 18a.

As illustrated in FIG. 4, the banknote storage device 11 has a conveying port 21 through which the banknotes 2, which are wound around the winding drum 13, are conveyed. A pinch roller 22 that forms a conveying path of the metal band 14a and a guide member 23 having a guide roller 24, are disposed in the conveying port 21. The pinch roller 22 is rotatably supported by a spindle 22a. The banknotes 2 conveyed to the conveying port 21 that are loaded in a state of being sandwiched by the pinch roller 22 and the guide roller 24 and that are guided toward a circumferential surface of the winding drum 13 by the guide member 23.

The supply reel 12 is supported by a rotating shaft 25 and one end of the metal band 14a, which forms the constant load spring 14, is fixed to the rotating shaft 25. The metal band 14a having one end fixed to the rotating shaft 25, is rolled around the rotating shaft 25. Moreover, the other end of the metal band 14a is fixed to the winding drum 13. The metal band 14a has a conductive property and an elastic property and has a thickness of approximately 0.1 mm and a width of approximately 20 mm. In the present embodiment, a conston (registered trademark) spring is used as an example of the constant load spring 14 formed of the metal band 14a. One end of the metal band 14a may be fixed to the inside of the supply reel 12.

As illustrated in FIG. 4, the metal band 14a supplied from the supply reel 12, is conveyed by the guide roller 18 so as to pass near the upper side of the winding drum 13. The metal band 14a is wound around the circumferential surface of the winding drum 13 with the conveying direction reversed by the pinch roller 22 of the conveying port 21.

The winding drum 13 is supported by a rotating shaft 26 and is rotated by a driving motor (not illustrated) included in a driving mechanism 28 as illustrated in FIG. 4. The driving motor of the driving mechanism 28 is electrically connected to a control unit 29 and is driven by the control unit 29.

In the present embodiment, when the metal band 14a is rewound around the supply reel 12, the driving motor is stopped by the control unit 29 and the winding drum 13 becomes freely rotatable. Due to this, the metal band 14a wound around the winding drum 13 is rewound around the supply reel 12 by a biasing force of the constant load spring 14. Therefore, it is possible to eliminate a transmission mechanism for transmitting the driving force of the driving motor to the supply reel 12 and is possible to contribute to reducing the size of the banknote storage device 11. However, the present invention is not limited to this operation, but the rotation of the supply reel 12 around which the metal band 14a is rewound by the biasing force of the constant load spring 14, may be supplemented. In this case, a configuration in which the supply reel 12 is rotated by the driving motor or a configuration in which the winding drum 13 is rotated in a reverse direction by the driving motor, may be employed as appropriate, for example.

[Configuration of First Detection Unit and Detection of End of Metal Band]

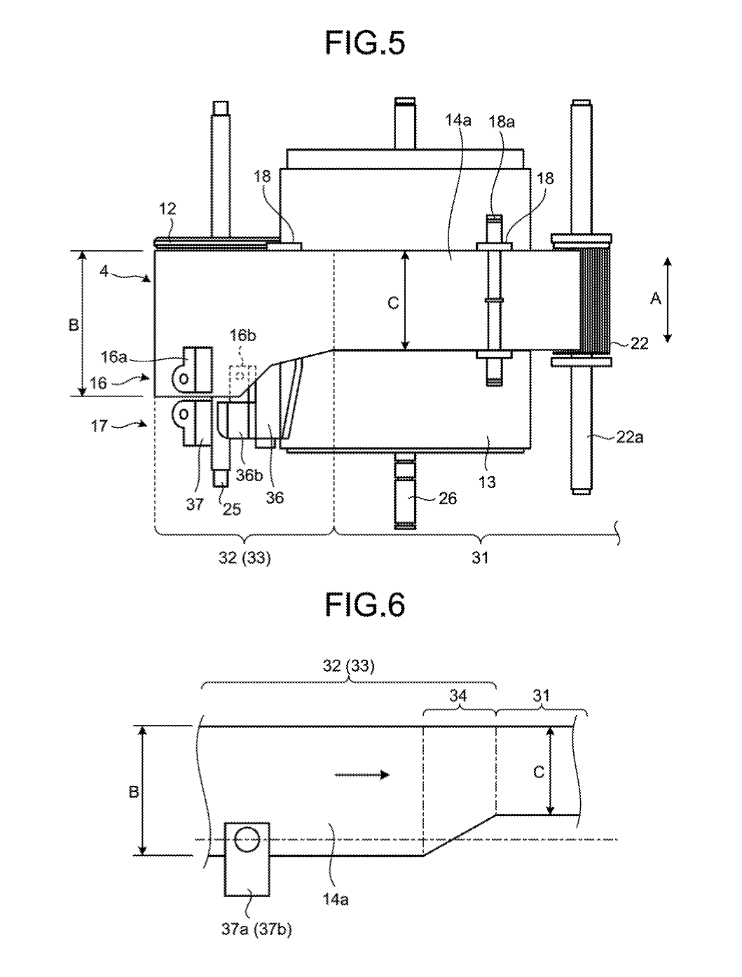

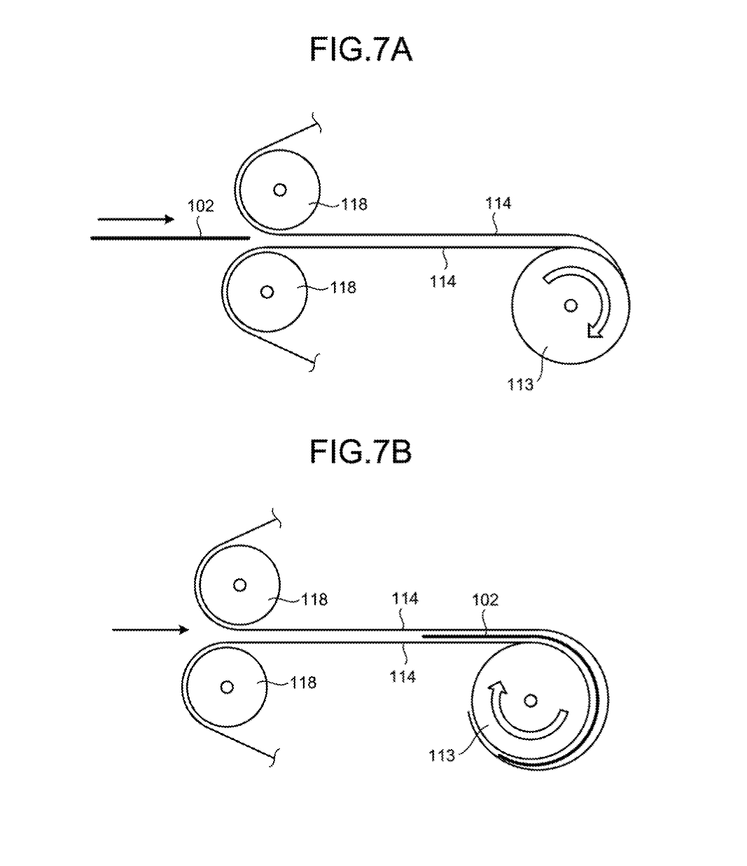

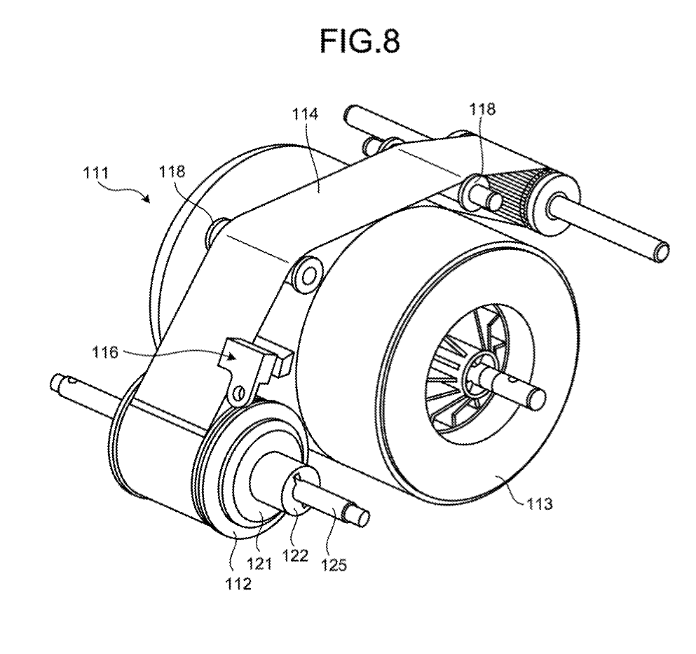

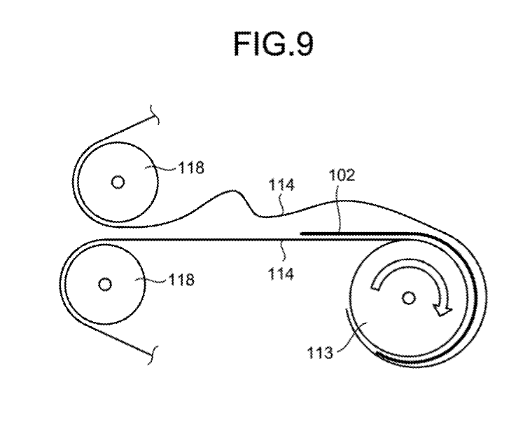

FIG. 5 is a plan view for describing a state, in which the end of the metal band 14a of the constant load spring 14 according to the embodiment, is detected. FIG. 6 is a schematic diagram for describing a state, in which the end of the metal band 14a of the constant load spring 14 according to the embodiment, is detected.

The first detection unit 16 is disposed near the conveying path of the metal band 14a drawn from the supply reel 12, and an optical sensor is used as the first detection unit 16. The optical sensor as the first detection unit 16 has a light emitting unit 16a that emits detection light and a light receiving unit 16b that receives the detection light emitted by the light emitting unit 16a. The light emitting unit 16a and the light receiving unit 16b are disposed to face each other in a thickness direction of the metal band 14a at such an interval that the metal band 14a passes therethrough. Moreover, as illustrated in FIG. 5, the light emitting unit 16a and the light receiving unit 16b are disposed at a position adjacent to one end in a width direction A of the metal band 14a. Moreover, as illustrated in FIG. 4, the light emitting unit 16a and the light receiving unit 16b are electrically connected to the control unit 29 and a detection signal is transmitted from the light receiving unit 16b to the control unit 29.

As illustrated in FIGS. 5 and 6, the metal band 14a of the constant load spring 14 has a starting end 32 and a terminal end 33 of which the width dimension B at both ends in the longitudinal direction is larger than the width dimension C of an intermediate portion 31 between both ends. That is, the starting end 32 and the terminal end 33 of the metal band 14a extend further than a position through which the optical axis of the detection light of the first detection unit 16 passes in relation to the width direction A of the metal band 14a. Moreover, the starting end 32 and the terminal end 33 that have a large width, include a transition portion 34 of which the width gradually increases from the width dimension C of the intermediate portion 31. Since the starting end 32 and the terminal end 33 have the transition portion 34, the metal band 14a is smoothly wound around the supply reel 12 and the winding drum 13.

In the first detection unit 16, the starting end 32 and the terminal end 33 of the metal band 14a move between the light emitting unit 16a and the light receiving unit 16b with a winding operation of the supply reel 12 or the winding drum 13 winding the metal band 14a. In this case, since the intermediate portion 31 of the metal band 14a does not block the detection light emitted by the light emitting unit 16a, a state, in which the light receiving unit 16b receives the detection light, is created. On the other hand, since the starting end 32 and the terminal end 33 of the metal band 14a block the detection light emitted by the light emitting unit 16a, a state, in which the detection light is not received by the light receiving unit 16b, is created. Therefore, the light receiving unit 16b detects the positions of the starting end 32 and the terminal end 33 of the metal band 14a when the state, in which the detection light is received, is changed to the state, in which the detection light is not received.

Upon detecting the starting end 32 of the metal band 14a, the first detection unit 16 transmits a detection signal to the control unit 29. Similarly, upon detecting the terminal end 33 of the metal band 14a, the first detection unit 16 transmits a detection signal to the control unit 29. Based on a detection signal of the terminal end 33 from the first detection unit 16, the control unit 29 stops the driving motor and stops the winding operation of the winding drum 13.

In this manner, when the first detection unit 16 detects both ends of the metal band 14a supplied from the supply reel 12, the control unit 29 calculates a supply amount of the metal band 14a (that is, the winding amount of the metal band 14a wound by the winding drum 13). The control unit 29 performs a predetermined calculation process based on the winding amount of the metal band 14a to count the number of banknotes 2 stored in a state of being wound around the winding drum 13.

In the present embodiment, although the width B of the starting end 32 and the terminal end 33 of the metal band 14a is formed to be larger than the width C of the intermediate portion 31, the metal band 14a is not limited to this shape, but the starting end 32 and the terminal end 33 may be formed in such a shape that the width dimension thereof changes in relation to the intermediate portion 31. The starting end 32 and the terminal end 33 of the metal band 14a may have a notch portion, in which the width dimension is smaller than the width dimension C of the intermediate portion 31. In this case, it is also possible to detect the starting end and the terminal end similarly to the present embodiment. Moreover, a detection hole for allowing the light receiving unit 16b to receive detection light, may be formed in both ends of the metal band 14a at a position through which the optical axis of the detection light, which is emitted by the light emitting unit 16a, passes.

In the present embodiment, although the first detection unit 16 is configured using an optical sensor, a rotary encoder, which detects a rotation amount of the rotating shafts 25 and 26 of the supply reel 12 and the winding drum 13, may be used.

[Configuration of Second Detection Unit and Detection of Winding Diameter of Winding Drum]

As illustrated in FIGS. 2 and 3, the second detection unit 17 is disposed at a position adjacent to the first detection unit 16. The second detection unit 17 includes a detection lever 36 as a detection member and an optical sensor 37. The detection lever 36 moves in contact with the winding drum 13 when the diameter of the winding drum 13, around which the banknotes 2 are wound together with the metal band 14a, is equal to or larger than a predetermined winding diameter. The optical sensor 37 detects the movement of the detection lever 36.

As illustrated in FIGS. 3 and 4, the detection lever 36 has a contactor 36a, which makes contact with the metal band 14a wound around the winding drum 13, and a detection piece 36b, which is detected by the optical sensor 37, and the detection lever 36 is rotatably supported by a spindle 36c.

The detection lever 36 is disposed at a predetermined attitude around the spindle 36c so that the contactor 36a makes contact with the winding drum 13 of which the outer diameter becomes equal to a predetermined winding diameter. When the detection lever 36 is at an initial position which is the predetermined attitude, the contactor 36a is separated from the winding drum 13 in a radial direction D of the winding drum 13. When the diameter of the winding drum 13 becomes equal to or larger than the predetermined winding diameter, the contactor 36a makes contact with the metal band 14a wound around the winding drum 13. In this way, the contact, between the metal band 14a and the detection lever 36, is suppressed as much as possible to prevent the detection lever 36 and the metal band 14a from wearing and being damaged, to enhance durability. Moreover, the detection lever 36 is biased around the spindle 36c by a torsion spring (not illustrated) so that the contactor 36a returns to the initial position.

As illustrated in FIGS. 2 and 3, the optical sensor 37 has a light emitting unit 37a, which emits detection light, and a light receiving unit 37b, which receives the detection light emitted by the light emitting unit 37a. As illustrated in FIG. 4, the light emitting unit 37a and the light receiving unit 37b are disposed to face each other in a radial direction of the spindle 36c of the detection lever 36 at such an interval that the detection piece 36b of the detection lever 36 can enter. As illustrated in FIG. 3, the light emitting unit 37a and the light receiving unit 37b are disposed on one end side in the width direction A of the metal band 14a. The light emitting unit 37a and the light receiving unit 37b are electrically connected to the control unit 29, and a detection signal is transmitted from the light receiving unit 37b to the control unit 29.

The predetermined winding diameter of the winding drum 13 is set to such a diameter (outer diameter) that the winding drum 13 does not interfere with other constituent members such as the guide member 23 disposed inside the banknote storage device 11. Particularly, in the present embodiment, the predetermined winding diameter is set to such a diameter that the winding drum 13, around which the banknotes 2 are wound, does not interfere with the conveying path of the metal band 14a supplied from the supply reel 12.

The second detection unit 17 transmits a detection signal to the control unit 29 upon detecting the winding drum 13 of which the outer diameter becomes equal to or larger than a predetermined winding diameter, when the contactor 36a of the detection lever 36 makes contact with the metal band 14a wound around the winding drum 13. Based on the detection signal from the second detection unit 17, the control unit 29 stops the driving motor and stops the winding operation of the winding drum 13.

When a folded banknote or a wrinkled banknote (hereinafter referred to as a worn-out banknote) is wound around the winding drum 13, the winding diameter of the winding drum 13 may become equal to or larger than an expected winding diameter. In such a case, according to the second detection unit 17, it is possible to stop the winding operation before the winding drum 13 interferes with the conveying path of the metal band 14a or another constituent member such as the guide member 23. In this way, it is possible to prevent damage and breakage of the winding drum 13 or the other constituent member to improve the reliability of the winding operation.

Although the second detection unit 17 according to the present embodiment uses one detection lever 36, a plurality of detection levers 36 may be arranged at an interval in the width direction A of the metal band 14a wound around the winding drum 13 as appropriate. Moreover, one detection lever 36 may have a plurality of contactors 36a arranged in the width direction A of the metal band 14a wound around the winding drum 13. For example, when the circumferential surface of the winding drum 13 is inclined in an axial direction (the width direction A of the metal band 14a) due to an inclination or the like of the rotating shaft 26 of the winding drum 13, the winding diameter of the winding drum 13 is biased in the axial direction of the winding drum 13. In such a case, at least one of the plurality of detection levers 36 or the plurality of contactors 36a makes contact with the metal band 14a wound around the winding drum 13 whereby the winding drum 13, of which the outer diameter becomes equal to or larger than the predetermined outer diameter, can be detected. Due to this, it is possible to improve the detection accuracy of the winding diameter of the winding drum 13.

Although the second detection unit 17 uses an optical sensor to detect the movement of the detection lever 36, the second detection unit 17 is not limited to the configuration in which the optical sensor is used. The second detection unit 17 may only need to have a configuration that detects the movement of the detection lever 36, and a pressure sensor or a press button switch, which is pressed by the detection lever 36 that moves, may be used. Moreover, a configuration, in which the light emitting unit and the light receiving unit of the optical sensor are disposed at an interval in an axial direction of the winding drum 13 so that the optical axis of the detection light passes through the position of the contactor 36a of the detection lever 36 at the initial position, may be employed. According to this configuration, it is possible to optically detect the winding drum 13 of which the outer diameter becomes equal to or larger than the predetermined outer diameter.

Moreover, the movement of the detection lever 36 may be detected by the first detection unit 16. In this case, by extending the detection piece 36b of the detection lever 36 up to the vicinity of the light receiving unit 16b of the first detection unit 16, it is possible to detect the movement of the detection lever 36 using the first detection unit 16. According to this configuration, since the first detection unit 16 also serves as the optical sensor 37 of the second detection unit 17, it is possible to eliminate the optical sensor 37 of the second detection unit 17, simplify the configuration, reduce the manufacturing cost, and reduce the size of the entire banknote storage device 11.

[Banknote Storage Operation]

An operation of winding the banknotes 2 around the winding drum 13 together with the metal band 14a in the banknote storage device 11 having such a configuration will be described.

In FIG. 4, when the winding drum 13 is rotated in the counter-clockwise direction by the driving mechanism 28, the metal band 14a is drawn from the supply reel 12 while resisting against the biasing force of the constant load spring 14. The metal band 14a, drawn from the supply reel 12, is conveyed along the conveying path of the guide roller 18 and is wound around the winding drum 13. In this case, the banknotes 2, loaded from the conveying port 21, are conveyed toward the circumferential surface of the winding drum 13 and are wound around the winding drum 13 in a state of being sandwiched between the metal band 14a and the circumferential surface of the winding drum 13. The metal band 14a, wound around the winding drum 13, is wound stably together with the banknotes 2 in a state, in which constant tension is applied by the biasing force of the constant load spring 14. Furthermore, since the banknotes 2 are wound around the winding drum 13 by the metal band 14a having a conductive property, even when the banknotes 2 are charged, electrostatic charges are removed from the banknotes 2 by the metal band 14a. As a result, it is possible to prevent the control unit 29 or the driving motor from being influenced by the charging of the banknotes 2. Moreover, the banknotes 2, loaded to the conveying port 21, are sequentially stored by being wound along the circumferential surface of the winding drum 13 together with the metal band 14a.

Subsequently, when the first detection unit 16 detects the terminal end 33 of the metal band 14a or the second detection unit 17 detects the winding drum 13 of which the outer diameter becomes equal to or larger than the predetermined outer diameter, the rotation of the winding drum 13 is stopped by the control unit 29. In this way, the winding drum 13 ends the operation of storing the banknotes 2.

On the other hand, after the driving of the winding drum 13 stops, when a state, in which the winding drum 13 can rotate in a reverse direction, is created, the metal band 14a is rewound around the supply reel 12 by the biasing force of the constant load spring 14. In this case, by the biasing force of the constant load spring 14, the supply reel 12 rotates in the counter-clockwise direction in FIG. 4 and the metal band 14a is rewound around the supply reel 12. The metal band 14a is rewound around the supply reel 12 and the metal band 14a is drawn from the winding drum 13, whereby the banknotes 2, wound around the winding drum 13 together with the metal band 14a, are discharged from the conveying port 21.

The banknote storage method in the banknote storage device 11 of the embodiment includes winding the banknotes 2 around the circumferential surface of the winding drum 13 together with the metal band 14a supplied from the supply reel 12 around which the metal band 14a, that forms the constant load spring 14, is rolled. Moreover, the banknote storage method according to the embodiment includes a step of detecting a supply amount of the metal band 14a supplied from the supply reel 12 using the first detection unit 16. In the detection step, the first detection unit 16 detects a change in the width dimension at the end in the longitudinal direction of the metal band 14a.

[Effects of Embodiment]

As described above, the banknote storage device 11 according to the embodiment includes the supply reel 12, which has the constant load spring 14 formed of the metal band 14a and around which the metal band 14a is rolled, and the winding drum 13, around which the banknotes 2 are wound together with the metal band 14a supplied from the supply reel 12. Due to this, since constant tension is applied to the metal band 14a by the biasing force of the constant load spring 14, it is possible to eliminate a torsion spring or a torque limiter, which has been used to apply constant tension. As a result, it is possible to eliminate the space in the shaft portion of the supply reel, in which a torsion spring or a torque limiter was disposed in the related art of the present application and to simplify and reduce the size of the structure of the supply reel 12. For example, the supply reel 12 can be formed in a simple cylindrical form using a resin. Therefore, according to the embodiment, it is possible to reduce the manufacturing cost of the banknote storage device 11.

In the banknote storage device 11 of the embodiment, since the banknotes 2 are wound around the winding drum 13 using the metal band 14a having a conductive property, even when charging occurs between the banknote 2 and the metal band 14a, the electrostatic charge can be removed by the metal band 14a appropriately. Due to this, it is possible to prevent the control unit 29 or the driving motor from being influenced by the charging of the banknote 2 and to improve the reliability of the operation of winding the banknotes 2.

In the banknote storage device 11 of the embodiment, since the banknotes 2 are wound around the winding drum 13 using the metal band 14a having an elastic property, it is possible to prevent the occurrence of such disorder or fluctuation of the tape as occurring when a tape formed of a resin film is used. As a result, it is possible to enhance the stability of the operation of winding the banknotes 2 and to improve the reliability of the banknote storage device 11. Moreover, due to the elastic property of the metal band 14a, it is possible to allow the banknotes 2 to smoothly adhere along the circumferential surface of the winding drum 13 and to enhance the property of storing the banknotes 2. Furthermore, since the metal band 14a itself has an elastic property, even when a worn-out banknote is wound around the winding drum 13, the worn-out banknote is appropriately sandwiched between the metal bands 14a. Due to this, a variation, in the winding diameter of the winding drum 13 due to worn-out banknotes, is suppressed.

Furthermore, in the related art of the present application, when a jam occurs during the winding operation, the tape may be damaged or broken when the entangled state of the tape formed of a resin film, is loosened, the maintenance property is poor and the durability of the banknote storage device is damaged. On the other hand, according to the banknote storage device 11 of the embodiment, since the durability of the metal band 14a itself is higher than the tape formed of a resin film, it is possible to easily alleviate the jam, improve the maintenance property, and improve the durability of the banknote storage device 11.

The banknote storage device 11 of the embodiment further includes the first detection unit 16, which detects the supply amount of the metal band 14a supplied from the supply reel 12. Moreover, the metal band 14a is formed so that the width dimension of the end in the longitudinal direction changes, and the end thereof is detected by the first detection unit 16. Due to this, even when the banknotes 2 are wound around the winding drum 13 using the metal band 14a, it is possible to reliably detect both ends of the metal band 14a and to count the number of banknotes 2 stored around the winding drum 13.

The banknote storage device 11 of the embodiment further includes the second detection unit 17 that detects the winding drum 13, of which the outer diameter becomes equal to or larger than the predetermined winding diameter. Due to the second detection unit 17, it is possible to prevent the winding drum 13 from interfering with the conveying path of the metal band 14a, supplied from the supply reel 12, or with the other constituent members in the banknote storage device 11, during the winding operation. As a result, according to the second detection unit 17, it is possible to prevent breakage of the winding drum 13 and the other constituent members and to improve the reliability of the winding operation of the winding drum 13.

The second detection unit 17 of the embodiment includes the detection lever 36, which moves in contact with the winding drum 13 of which the outer diameter becomes equal to or larger than the predetermined winding diameter, and the optical sensor 37, which detects the movement of the detection lever 36. Due to this, it is possible to detect the winding diameter of the winding drum 13 with a simple configuration and to suppress an increase in the manufacturing cost of the banknote storage device 11. Moreover, according to the embodiment, it is possible to reliably stop the operation of winding the banknotes 2 using the first detection unit 16 and the second detection unit 17.

The present embodiment may be applied to a configuration in which banknotes are wound around the winding drum together with two metal bands while the banknotes are sandwiched between the facing metal bands supplied from two supply reels. Moreover, the present embodiment may be applied to a configuration in which banknotes are wound around the winding drum together with a plurality of metal bands arranged in parallel in the axial direction of the winding drum.

According to an aspect of the paper sheet storage device disclosed in the present application, it is possible to simplify the structure of a supply reel and to prevent charging of a paper sheet to improve the reliability of a paper sheet winding operation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A paper sheet storage device comprising:
a supply reel which has a constant load spring formed of a metal band and around which the metal band is rolled; and
a winding drum around which a paper sheet is wound together with the metal band supplied from the supply reel.

2. The paper sheet storage device according to claim 1, further comprising
a first detection unit that detects a supply amount of the metal band supplied from the supply reel, wherein
the metal band is formed so that a width dimension of an end thereof in a longitudinal direction changes and the end is detected by the first detection unit.

3. The paper sheet storage device according to claim 1, further comprising
a second detection unit that detects the winding drum of which the outer diameter becomes equal to or larger than a predetermined outer diameter.

4. The paper sheet storage device according to claim 3, wherein
the second detection unit has a detection member that moves in contact with the winding drum of which the outer diameter becomes equal to or larger than the predetermined outer diameter and a sensor that detects the movement of the detection member.

5. A paper sheet storage method comprising:
winding a paper sheet around a winding drum together with a metal band supplied from a supply reel around which the metal band, which forms a constant load spring, is rolled.

6. The paper sheet storage method according to claim 5, further comprising
detecting a supply amount of the metal band supplied from the supply reel using a detection unit, wherein
the detection unit detects a change in a width dimension of an end in a longitudinal direction of the metal band.
